(19) United States
(12) Patent Application Publication
(10) Pub. No.: US 2024/0369175 A1
(43) Pub. Date: Nov. 7, 2024

(54) METHOD FOR FIXING THE PROTECTIVE FABRIC ON INSULATION TAPE FOR BURIED PIPES

(71) Applicant: Hamad ABABUTAIN, Riyadh (SA)

(72) Inventor: Hamad ABABUTAIN, Riyadh (SA)

(21) Appl. No.: 18/770,784

(22) Filed: Jul. 12, 2024

Related U.S. Application Data
(63) Continuation-in-part of application No. PCT/SA2023/050002, filed on Jan. 10, 2023.

(30) Foreign Application Priority Data
Jan. 12, 2022 (SA) 122430537

(51) Int. Cl. F16L 59/15; F16L 59/02

(52) U.S. Cl. CPC F16L 59/15; F16L 59/027; F16L 59/029

(57) ABSTRACT

A method for protecting underground pipes by applying three layers of different materials to an outer surface of a pipe is accomplished by wrapping three layers of different materials on the pipe outer surface. The three layers are: The first layer: which surrounds the pipe, is the insulating tape known as cold wrap tape. The second layer: which follows the first layer, made from non-woven synthetic wool, and called the protector. The third layer: the fixing tape made of synthetic fabric that contains fine hooks that can grip tight the second layer—the protector—and prevent it from delamination and falling. Second and third layers act together as Velcro to securely fix and protect the first layer (cold roll tape) from the mechanical damage of soil and tamping over the pipe and UV during the of installation period and before backfilling.

### CROSS REFERENCE TO THE RELATED APPLICATIONS

This application is the continuation-in-part application of International Application No. PCT/SA2023/050002, filed on Jan. 10, 2023, which is based upon and claims priority to Saudi Arabian Patent Application No. 122430537, filed on Jan. 12, 2022, the entire contents of which are incorporated herein by reference.

### TECHNICAL FIELD

This invention relates to wrapping a corrosion protective tape known as cold wrap tape wrapped over buried steel pipes, where the protective tape prevent water in the soil from reaching the pipe's surface causing it to corrode.

### BACKGROUND

To lay the buried pipes underground, a trench is made along the path, then the pipes are laid in this trench, and welded together to form a long pipeline. After completing the laying of the pipes, the trench is then backfilled with soil on the pipe to bury it. Burying pipes underground is normal and does not harm them, as they are made from specially specified steel to ensure that it can pass the fluid inside it and withstand the stresses surrounding its external surface. The predominant material from which the pipes are made is carbon steel, and because this type of material is not corrosion resistant, pipes are covered at factory with corrosion proof protective coatings to protect them from corrosion that in turn well lead to pipe leakages of what is inside, especially since pipelines are under high internal pressures.

Pipes ends (joints-welding areas), however, cannot be coated at factory as welding will result in burning of the protective material due to the excessive welding heat, and must be coated at site after welding and before burying. Fittings and pipe spools which can't be coated at factory are also coated at site.

The best technology currently in use is to wrap a tape containing adhesive from one side, known as cold wrap tape around the pipe, called here the insulating layer. This tape sometime is protected by a second protective fabric-called here the protective layer-made of a non-woven synthetic faux wool fabric. The second protective layer protects the first tape—the cold wrapped tape—from the backfilled soil stresses that surrounds the pipe after burying, and since the second layer (the protective tape (the fabric)) does not contain adhesives, it is tightened in place with a duct tape (pressure sensitive packaging tape). This third layer is called here the fixing tape, and the need for this tape is ceded for after burial and soil compaction, so the need for it is temporal, from wrapping to burial, backfilling and compacting only.

The problem lies in the duct tape (the third installed layer), where the pipe may remain exposed for several days or weeks before burial. And during or before backfilling into the trench and with direct exposure to sun light and then the mechanical movement of soil during backfilling, this duct tape which has lost its adhesion will not stick and subsequently falls, especially in hot climate, and as a result the protective fabric layer (FIG. 1) surrounding the insulating tape—the cold wrapped tape—get loosened, making it fails to maintain its function in Protecting the insulating tape, which in turn—the insulating tape—sag and wrinkles forming pockets that allow water to reach the surface of the pipe and cause it to corrode, causing leakage of the pipe content.

Since the use of duct-packaging pressure sensitive-tape to fix the protector (fabric) is impractical and requires immediate burial of the pipe, we have replaced it with Velcro hooks tape, a fabric containing precise hooks that have the ability to mechanically hold the synthetic wool fabric in the second protective layer tight. These Velcro hooks are less affected by environment than duct tape because their way of working is mechanical anchor, with no adhesive needed, and therefore they can retain their ability to grasp the fabric for several weeks.

### SUMMARY

The invention pertains to the protection of buried underground pipes, often constructed from carbon steel. Due to the susceptibility of carbon steel to corrosion, these pipes are typically coated with a protective layer at the factory. However, this coating is absent at the ends, where welding joints are located. During welding, the excessive heat generated burns away the protective material. Consequently, joints, spools, and fittings need to be protected by a coating applied on-site after welding and before the pipes are buried. This coating prevents surface water in the soil from corroding these areas, which could otherwise damage the pipe and lead to leaks.

The invention involves a method to protect buried pipes from soil water corrosion by wrapping them in three distinct layers. These layers are designed to offer both adhesive and mechanical protection to ensure the pipe's longevity and integrity. The three layers are described as follows:
1—First Layer: Insulating Tape
   This layer consists of an “insulating tape,” commonly referred to as cold wrap tape.
   It features an adhesive on one side that allows it to stick directly to the surface of the pipe.
   This layer serves as the primary barrier against corrosion by preventing direct contact between the pipe and the surrounding soil.
2—Second Layer: Protector
   Positioned over the insulating tape, this layer is made from non-woven synthetic faux wool fabric.
   Its main function is to protect the insulating tape from mechanical damage that might occur during the burial process, such as backfilling or tamping of the soil.
3—Third Layer: Velcro Hooks Tape
   This layer consists of Velcro hooks tape, equipped with fine hooks.
   These hooks grip and securely hold the second layer (the faux wool fabric protector) in place.
   The combination of the second and third layers creates a Velcro effect, ensuring that the protector remains fixed and continues to safeguard the first layer (the insulating tape) from soil and mechanical impacts.

The layered approach of this invention ensures that the buried pipes are adequately protected from both corrosion and mechanical damage caused by soil and the burial process. The first layer provides an adhesive barrier against corrosion, while the second and third layers work together to maintain the integrity of this barrier and protect it from physical damage.

### BRIEF DESCRIPTION OF THE DRAWINGS

FIG. 1: A cross section of the pipe showing the mechanical effects on the protective tape surrounding the pipe and the formation of pockets during backfilling, allowing water to leak.

FIG. 2: shows a longitudinal section of the pipe and the first insulating layer.

FIG. 3: Shows how fabric with fine hooks grips the faux wool fabric.

FIG. 4: shows the method of fixing the Velcro hooks tape on the synthetic wool tape.

### DETAILED DESCRIPTION OF THE EMBODIMENTS

FIG. 1 shows a pipe (1) in a trench (4) and clearly shows the mechanical effect of the soil on the cold wrap tape (2) (or the insulating tape) surrounding the pipe (1) during the process of backfilling and tamping, as the wide arrows (8) are shown in FIG. 1. The mechanical direction of soil movement during backfilling and its effect on the cold wrap tape (2) especially from the sides of the pipe (1) from the point of its contact with the trench floor (4) where the cold wrap tape moves (2) due to the movement of the backfill downward forming pockets (3)) The sagging of the cold wrap tape (2) is caused by the mechanical action of the backfill.

To reduce the effect of soil backfilling on the cold wrap tape (2), a non-woven fabric of synthetic faux wool is wrapped (5) called the protector, and the protector (5) is fixed with duct tape pressure sensitive packaging with adhesive from one side adhesive (not shown in the drawings), but weather and Heat from sun and dust lead to weakening the adhesive on the duct tape, thus not tightening the protector (5) and thus weakening the tension of the cold wrap tape (2) on the pipe (1). So, the cold wrap tape (2) is wrapped on the pipes, and it must be protected with a protective layer (5) that protects it from the movement of the surrounding soil, especially during backfilling. It sags and wrinkles forming pockets (3) that allow water to enter to the outer surface of the pipe (1), and with time groundwater leakage, the pipe corrodes, and this leads to pipe ruined (1) and the leakage of what goes through the pipe (1) to the soil.

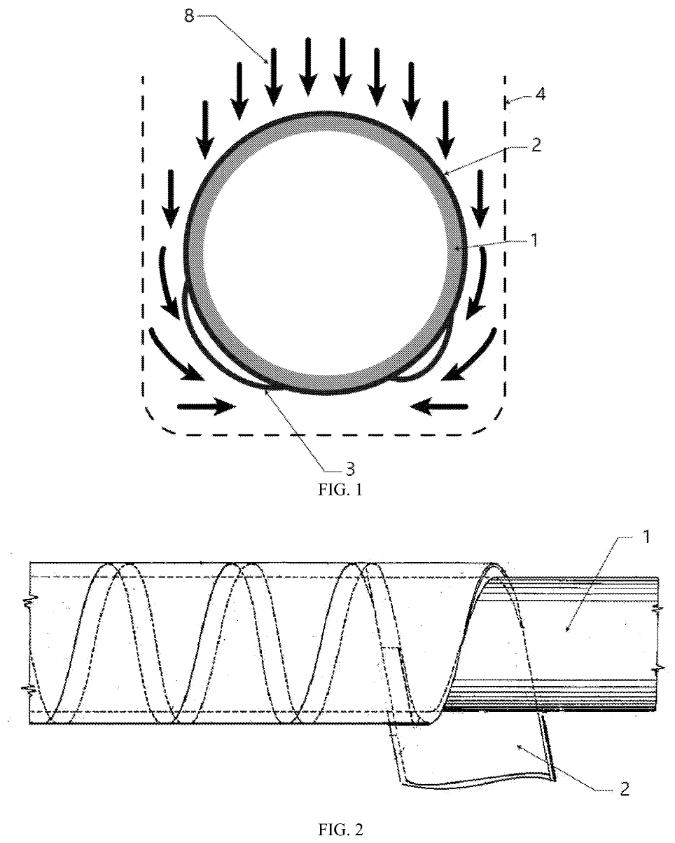

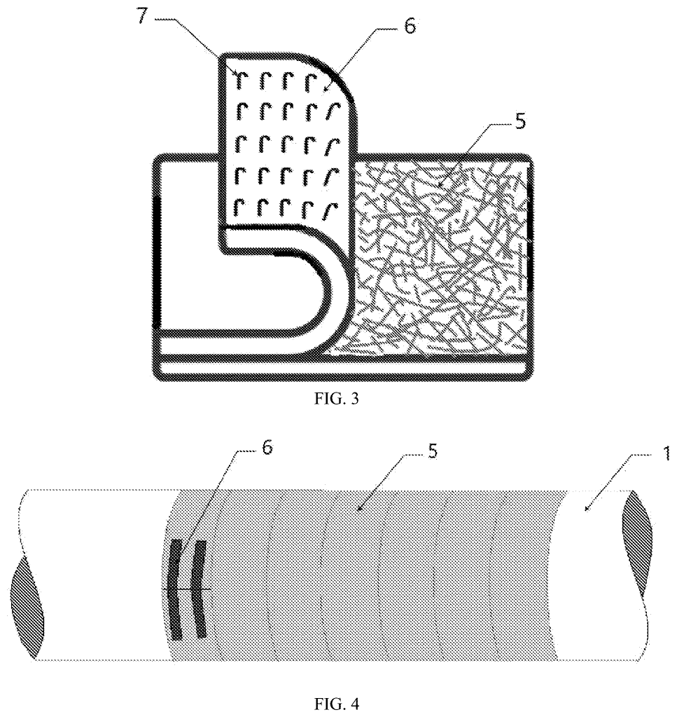

To avoid the problem of forming pockets (3), the cold wrap tape (2) should be secured to the pipe (1), and as shown in FIG. 2, the pipe (1) is protected by cold wrap tape (2), and then a layer of non-woven fabric made from synthetic faux wool is wrapped on top of it (5), where this layer performs two functions, the first is to protect the cold wrap tape layer (2) located below it from mechanical damage that the soil may cause during backfill, and thus maintain the quality of the cold wrap tape (2) its integrity which will protect the pipe (1) from damage, as it will also hold the synthetic wool (5) the third layer made of fine fabric hooks (6), where the two layers of synthetic wool (5) and the hooks (6) work as Velcro® (FIGS. 3 and 4) to secure the cold wrap tape (2) and the synthetic wool layer (5), thus reducing the damage to the cold wrap tape (2) during backfilling, as the soil will first hit the synthetic wool layer (the protector) (5), which will absorb the stress of the soil and its movement over it and any mechanical operations above the ground after backfilling, such as compacting the ground, for example. Then the tightness of the protective tape (5) or the cold wrap tape (2) will prevent the formation of wrinkles and pockets (3) from which underground water seeps into a pipe (1).

FIG. 3 shows the installation of the synthetic wool layer (5), and the hook layer (6), where the hooks work to connect with the bristles of the synthetic wool layer (the protector) (5) to secure the synthetic wool fabric (5) in place after it is wrapped on the cold tape (protector) (2). As shown in FIG. 4, the layer of hooks (6) is fixed on the layer of synthetic wool (5) in the positions of the ends and the beginnings often, and some hooks tapes (6) may be used in other places for fixing as needed.

1. A method for protecting underground pipes by applying three layers of different materials to an outer surface of a pipe, comprising:
wrapping a first layer of insulating tape with adhesion ability, known as cold wrap tape, directly around a perimeter of the outer surface of the pipe before burying the pipe, particularly at welded joints, small joints, and pieces such as elbows and branches that are not factory-coated and are only coated on-site;
wrapping a second layer of synthetic wool of non-woven fabric, known as a protector, over the first layer; and
wrapping a third layer of fabric with fine hooks that grip tightly to bristles of the second layer of synthetic wool of non-woven fabric.

2. The method of claim 1, wherein the first layer of insulating tape is applied to areas where one pipe is welded to another and places adjacent to welding sites.

3. The method of claim 1, wherein the third layer of fabric is configured to grip tightly bristles of a faux wool fabric of the second layer to enhance an overall protection of the pipe.
